(19) United States
(12) Patent Application Publication
(10) Pub. No.: US 2005/0145419 A1
(43) Pub. Date: Jul. 7, 2005

(54) SCALE FOR DETERMINING A MASS FLOW RATE IN ACCORDANCE WITH THE DIFFERENTIAL PRINCIPLE

(76) Inventors: Martin Deters, Bissendorf (DE); Rolf Michels, Bad Oeynhausen (DE); Wolfgang Schaefer, Loehne (DE); Joerg Moeller, Buende (DE)

Correspondence Address: PROSKAUER ROSE LLP;PATENT DEPARTMENT, 1585 BROADWAY, NEW YORK, NY, 10036-8299, US

(21) Appl. No.: 10/484,998

(22) PCT Filed: Jun. 6, 2003
(86) PCT No.: PCT/EP03/05945

(30) Foreign Application Priority Data
Jun. 14, 2002 (DE) 102 26 722.7

(51) Int. Cl. G01G 13/00

(52) U.S. Cl. 177/105; 73/223; 177/161; 222/77

(57) ABSTRACT

The invention pertains to a scale for determining the mass flow rate of bulk materials in accordance with the differential principle. In order to decouple a receptacle (1) that is freely suspended on a weighing device (1b, 1c) and arranged upstream of a processing machine, in particular, an extruder (10), from the bulk material flowing from a filling funnel (2) arranged directly above the open-top receptacle (1), a bottom outlet (2b*) of the filling funnel (2) can be closed with a slide gate (5) that is supported in a pivoted fashion and provided with a downwardly directed stripping edge (5b) on its front end. During the pivoting of the slide gate, this stripping edge clears the material backing up directly underneath the slide gate and thusly ensures the aforementioned decoupling.

The invention pertains to a scale for determining the mass flow rate of a bulk material, such as a granulate, a powder, a ground stock, etc., in accordance with the differential principle, wherein said scale comprises a receptacle with an outlet, a weighing device that carries the receptacle and a filling funnel that is arranged directly above the open-top receptacle and provided with a bottom outlet that can be closed, wherein the closing means consists of a slide gate that can be transversely displaced into the mass flow.

Scales of this type are generally known. They are used, for example, in extrusion plants in order to control the extruder in dependence on the mass flow rate and/or to obtain information on the weight per meter of the extruded product.

In one known embodiment of such a scale for determining a mass flow rate, the closing means at the bottom outlet of the filling funnel arranged above the receptacle is realized in the form of a pinch-off valve with an elastic membrane. This membrane makes it possible to reduce or even close the flow cross section by means of air pressure. It is also known to utilize butterfly valves or plate-shaped shut-off elements (flat gate valves) that can be displaced into the material flow. When using this type of closing elements, it may occur that the material is compacted when the outlet is closed.

It is necessary to temporarily close the upstream filling funnel in order to obtain definitive measuring values in the gravimetric differential measuring method. Measuring errors can occur if the bulk material remains in contact with the closing unit or the material is backed up to the filling funnel such that the filling funnel is practically supported on the bulk material in the receptacle.

The invention is based on the objective of developing a scale of the initially described type, in which the bulk material is not subjected to any stresses when the filling funnel is closed and in which an automatic decoupling between the receptacle and the filling funnel is ensured.

In a scale of the initially cited type, this objective is attained due to the fact that the slide gate is realized in the form of a downwardly directed stripping edge on its front end.

In a scale of this type, a free space is created in the receptacle above the possibly backed-up material by the downwardly directed stripping edge. This means that the weighing device only weighs the receptacle with its bulk material content. When using the initially described pinch-off valves, the material is subjected to stresses during the closing process due to its compression and, if applicable, compaction. This is prevented by realizing the invention such that the edge of the bottom outlet is spaced apart from the slide gate and the slide gate protrudes over said edge, namely in such a way that the material outlet is blocked in consideration of the angle of repose of the bulk material. The slide gate should be spaced apart by a distance that is greater than the grain size of the bulk material such that crushing of the material is prevented in any case.

With respect to mechanical considerations, as well as the technical design of the closing drive, it is advantageous to realize the slide gate in the form of a shovel that is supported in a pivoted fashion. In this case, the pivoted shovel preferably is curved toward the bottom outlet in the shape of a hollow cylinder.

In order to upwardly seal the scale, in particular, when processing powdery bulk material, the filling funnel may be carried by a carrier plate arranged above the slide gate, the intermediate space may be provided with a flexible seal, and the pivoted slide gate may be coupled to a pivoting drive in the form of a piston-cylinder unit that extends through the carrier plate in a sealed fashion via a ball-and-socket joint.

The invention is described in greater detail below with reference to one embodiment that is schematically illustrated in the figures. The individual figures show:

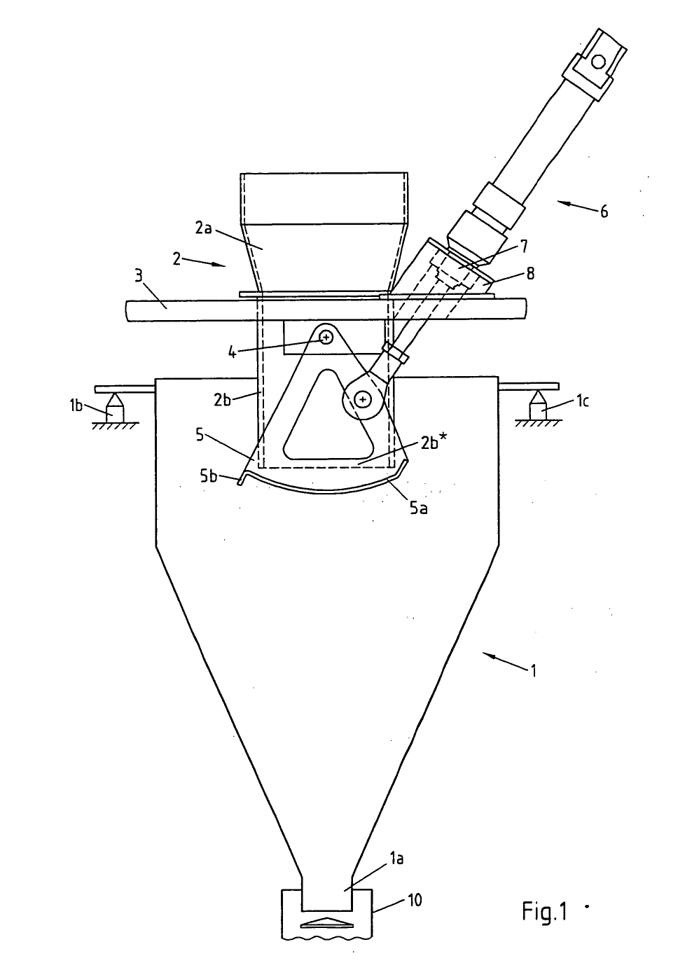

FIG. 1 a side view of a scale arranged above the inlet of an extruder;

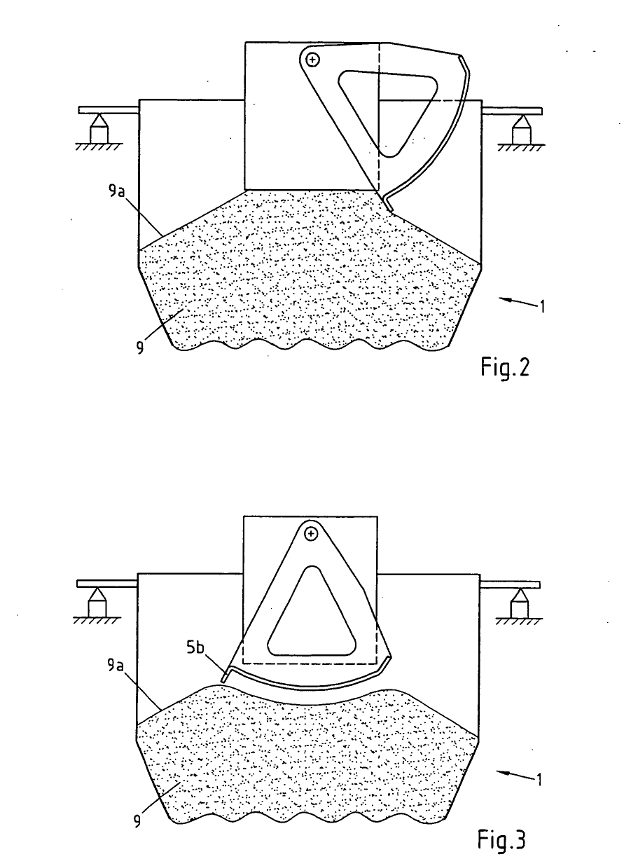

FIG. 2 an enlarged detail of the scale according to FIG. 1 in the region of the receptacle of the weighing device, namely while the filling funnel is open, and

FIG. 3 an enlarged detail of the scale according to FIG. 1 in the region of the receptacle of the weighing device, namely immediately after closing the bottom outlet of the filling funnel.

The figures show schematic side views and partial vertical sections through a scale for determining a mass flow rate in accordance with the differential principle. The scale comprises a weighing receptacle in the form of a receptacle 1 that is provided with a bottom outlet 1a. The receptacle 1 is freely support on load cells 1b, 1c of a weighing device. The receptacle outlet 1a leads, for example, into the inlet funnel 10 of a not-shown extruder.

A filling funnel 2 that essentially consists of an upper funnel-shaped section 2a and a lower cuboid or cylindrical section 2b is arranged above and partially in the receptacle 1. The filling funnel 2 is carried by a stationary plate 3 that essentially covers the top of the receptacle 2. The lower cylindrical section 2b contains a bottom outlet 2b* that can be closed with a closing means. A shovel 5 that is supported in a pivoted fashion in a bearing 4 on the plate 3 serves as the closing means. The shovel 5 consists of a blade 5a that this curved toward the bottom outlet 2b* in the shape of a hollow cylinder and provided with a stripping edge 5b on the underside of its front end. The blade 5a does not tightly adjoin the lower edge of the bottom outlet 2b*, but rather is spaced apart therefrom. The blade also protrudes over the edge of the bottom outlet 2b* on all sides.

A piston-cylinder arrangement 6 is used for pivoting the shovel 5, wherein said piston-cylinder arrangement extends through the plate 3 in a sealed fashion within a connection piece 8, namely via a ball-and-socket joint 7.

A natural cone 9a is formed by the rising bulk material 9 in the receptacle 1 while the system is in operation and the bottom outlet 2b* is open. This means that a closed column of bulk material 9 which extends upward into the filling funnel 2 is formed in the receptacle 1. Such a column would lead to a false result of the weight measurement. However, this is prevented with the stripping edge 5b provided on the front end of the shovel 5. According to the figure, the stripping edge 5b clears the region situated directly underneath the filling funnel when the blade is pivoted into the closed position shown in the figure such that the receptacle 1 is decoupled from the filling funnel 2. This means that the receptacle 1 with its contents can now be correctly weighed.

In order to prevent the material from being compressed or compacted by the shovel when the filling funnel 2 closed, the blade 5a is vertically spaced apart from the lower edge of the bottom outlet 2b* as described above. In addition, the blade laterally protrudes over the edge of the bottom outlet, namely such that the material flow from the filling funnel 2 to the receptacle 1 is completely interrupted in consideration of the natural angle of repose of the bulk material.

1. A scale for determining the mass flow rate of bulk materials in accordance with the differential principle, comprising a receptacle with an outlet, a weighing device that carries the receptacle and a filling funnel that is arranged directly above the open-top receptacle and contains a bottom outlet that can be closed, wherein a slide gate that can be transversely displaced into the mass flow is provided at the closing means, wherein the slide gate is realized with a downwardly directed stripping edge on its front end.

2. The scale according to claim 1, wherein the edge of the bottom outlet is spaced apart from the blade of the slide gate and the blade protrudes over said edge, namely such that the material flow is interrupted in consideration of the angle of repose of the bulk material.

3. The scale according to claim 1, wherein the slide gate is realized in the form of a pivoted shovel.

4. The scale according to claim 1, wherein the blade of the pivoted shovel is curved toward the bottom outlet in the shape of a hollow cylinder.

5. The scale according to claim 1, wherein the filling funnel is carried by a carrier plate that is arranged above the slide gate, and wherein the pivoted slide gate is coupled to a pivoting drive that is realized in the form of a piston-cylinder unit and extends through the carrier plate in a sealed fashion via a ball-and-socket joint.

6. The scale according to claim 1, wherein the intermediate space between the carrier plate and the receptacle is encapsulated by means of a flexible, gas-tight and dust-tight element that separates the bulk material from the surroundings.
